(19) United States
(12) Patent Application Publication
(10) Pub. No.: US 2013/0134785 A1
(43) Pub. Date: May 30, 2013

(54) SINGLE STAGE POWER CONVERSION SYSTEM

(71) Applicants: Kathleen Ann O'Brien, Niskayuna, NY (US); Ralph Teichmann, Niskayuna, NY (US)

(72) Inventors: Kathleen Ann O'Brien, Niskayuna, NY (US); Ralph Teichmann, Niskayuna, NY (US)

(73) Assignee: GENERAL ELECTRIC COMPANY, SCHENECTADY, NY (US)

(21) Appl. No.: 13/307,133

(22) Filed: Nov. 30, 2011

(51) Int. Cl. H02J 1/10; H02J 1/00

(52) U.S. Cl. 307/71; 307/43; 307/77

(57) ABSTRACT

A solar power generation system includes photovoltaic modules electrically coupled to each other for generating DC power having a voltage at least as large as a minimum threshold voltage but no greater than a maximum threshold voltage. The system also includes a DC-AC power converter including a plurality of semiconductor switches for converting the DC power to AC power for transmission to a power grid. The minimum threshold voltage is based at least in part on grid voltage requirements, and the maximum threshold voltage is based on a voltage rating of the power converter.

### BACKGROUND

The invention generally relates to power conversion systems.

With the rising cost and scarcity of conventional energy sources and concerns about the environment, there is a significant interest in alternative energy sources such as solar power and wind power. Solar power generation uses photovoltaic sources to generate electricity from the sun. Multiple photovoltaic sources are electrically coupled to one another in such systems to generate electricity. The electricity is supplied to utilities via a power distribution network including a power grid.

A power conversion system provides an output voltage to the power grid based on specific requirements. One type of conventional power conversion system comprises a DC-DC boost converter, a DC-AC inverter, and a step-up transformer for providing the output power to the power grid. DC power generated by the photovoltaic sources is transmitted to the DC-DC converter. The DC-DC converter boosts the DC voltage of the DC power before transmitting the DC power to the DC-AC inverter for converting the DC power to AC power. The AC power is transmitted to the step-up transformer for increasing the AC voltage of the AC power to provide a required output power that is fed to the power grid. Such power conversion systems may be bulkier and more expensive than desired for certain applications.

Another type of conventional power conversion system comprises a DC-AC inverter, and a step-up transformer for providing the output power to the power grid. DC power generated by the photovoltaic sources is transmitted directly to the DC-AC converter. The DC-AC inverter converts the DC power to AC power. The AC power is transmitted to the step-up transformer for increasing the AC voltage of the AC power to provide a required output power that is fed to the power grid.

An increase in power hardware components in power conversion systems tends to increase the system cost and size while reducing the system efficiency and reliability. Loss of efficiency increases the cost of electricity generated by the power conversion system.

Hence, there is a need for an improved system to address the aforementioned issues.

### BRIEF DESCRIPTION

In one embodiment a solar power generation system is provided. The system includes a plurality of photovoltaic modules electrically coupled to each other for generating DC power having a voltage at least as large as a minimum threshold voltage but no greater than a maximum threshold voltage. The system also includes a DC-AC power converter that further includes a plurality of semiconductor switches for converting the DC power to AC power and transmitting the AC power to a power grid. The minimum threshold voltage is based at least in part on grid voltage requirements, and the maximum threshold voltage is based on voltage rating of the power converter.

In another embodiment, a method for fabrication of a solar power generation system is provided. The method includes coupling a plurality of photovoltaic modules to each other for generating DC power having a voltage at least as large as a minimum threshold voltage, based at least in part on grid voltage requirements, but no greater than a maximum threshold voltage. The method also includes coupling the plurality of photovoltaic modules to a DC-AC power converter. The maximum threshold voltage is based at least on part on a voltage rating of the DC-AC power converter.

In yet another embodiment, a method for generating AC power is provided. The method includes using a plurality of photovoltaic modules electrically coupled to each other for generating DC power having a voltage at least as large as a minimum threshold voltage. The method also includes transmitting the DC power to a DC-AC power converter including a plurality of semiconductor switches for converting the DC power to AC power. The DC-AC power converter is turned off when a voltage less than the minimum threshold voltage is provided by the plurality of photovoltaic modules.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a solar power generation system including a three level three phase DC-AC power converter in accordance with an embodiment of the invention.

FIG. 2 is a schematic representation of an alternative embodiment of a solar power generation system including another three level three phase DC-AC power converter in accordance with an embodiment of the invention.

FIG. 3 is a schematic representation of a solar power generation system including a two level three phase DC-AC power converter in accordance with an embodiment of the invention.

### DETAILED DESCRIPTION

Embodiments of the present invention include a solar power generation system that operates without the need for a boost converter and a step up transformer. The system includes a plurality of photovoltaic sources that are electrically coupled to each other and generate DC power. In one embodiment, the plurality of photovoltaic modules are electrically coupled each other in an ungrounded state. The DC power generated by the plurality photovoltaic modules includes a voltage equal to at least a minimum threshold voltage based at least in part on grid voltage requirements and does not exceed a maximum threshold voltage that is based on a voltage rating of a DC-AC power converter installed in the solar power generation system. The DC-AC power converter is electrically coupled to the plurality of photovoltaic modules and converts the DC power to an AC power comprising a grid voltage that is fed to a power grid.

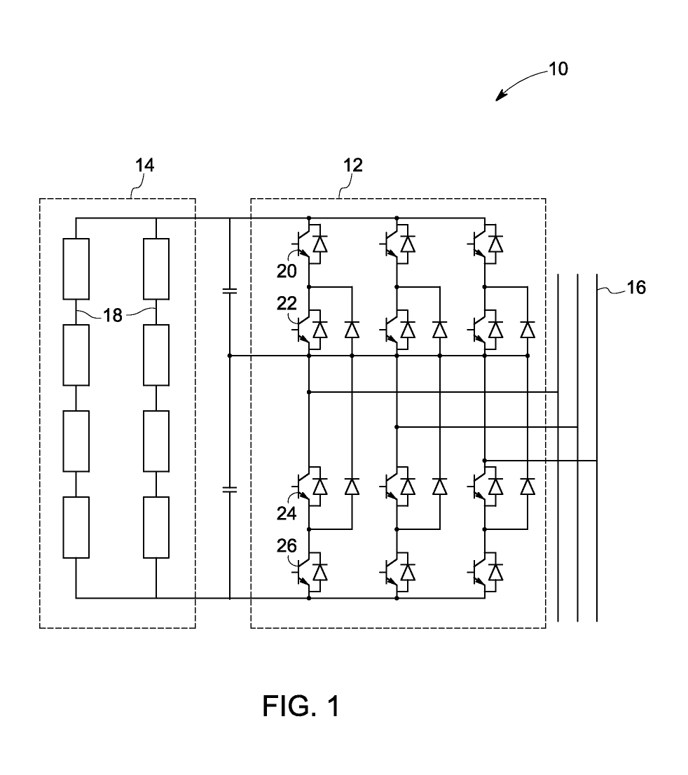

FIG. 1 is a schematic representation of a solar power generation system 10 including a DC-AC power converter 12 wherein the DC-AC power converter 12 comprises a three level three phase DC-AC power converter in accordance with an embodiment of the invention. The system 10 includes a plurality of photovoltaic modules 14 electrically coupled to each other for generating DC power. The DC power is transferred to the DC-AC power converter 12 that converts the DC power to AC power and transmits the AC power to a power grid 16. The number and type of coupling of plurality of photovoltaic modules 14 for generating the DC power is determined based on the grid voltage requirements during installation of the solar power generation system 10. The control mode of the DC-AC power converter is defined to accommodate varying grid and environmental conditions while maximizing the utilization of the components of the solar power generation system.

Each power grid 16 has a grid requirement code that specifies a nominal grid voltage and a grid voltage tolerance for the AC power to be supplied to the power grid 16 from the DC-AC power converter 12. In one embodiment, the grid voltage requirement is defined as a nominal line to line root mean square voltage (Vₗₗ_{_{—}}ᵣₘₛ) of the solar power generation system 10. During installation, the grid voltage requirement (Vₗₗ_{_{—}}ᵣₘₛ) is identified from the grid code, and a minimum threshold voltage is determined. In a specific embodiment, the minimum threshold voltage is defined as a minimum DC bus voltage (V_{dc-bus}_{_{—}}ₘᵢₙ) that is transferred from the plurality of photovoltaic modules 14 to the DC-AC power converter 12 in the solar power generation system 10. The minimum threshold voltage may further include a primary minimum threshold voltage (V_{dc-bus}_{_{—}}ₘᵢₙ₁) and a secondary minimum threshold voltage (V_{dc-bus}_{_{—}}ₘᵢₙ₂) that drives the operation of the power converter in a two level mode and a three level mode respectively. In this embodiment, at primary minimum voltage threshold V_{dc-bus}_{_{—}}ₘᵢₙ₁, the three-level converter will be operated as a two-level converter, and switches 20, 22, and 24, 26 of each phase leg will be gated synchronously. As the dc bus voltage rises above secondary minimum threshold voltage (V_{dc-bus}_{_{—}}ₘᵢₙ₂), the three-level DC-AC converter can be operated in three-level mode. Furthermore, if the dc bus voltage reduces below the secondary minimum threshold voltage again, the power converter is operated in the two level converter mode.

In one embodiment, the primary minimum threshold voltage (V_{dc-bus}_{_{—}}ₘᵢₙ₁) for a DC-AC three phase power converter installed in the solar power generation system 10 may be represented by the following equation

Vdc_bus_min1=π/4×√2×Vll_rms

and the secondary minimum threshold voltage may be represented by

Vdc_bus_min2=√2×Vll_rms.

Additionally, a maximum threshold voltage is identified from a voltage rating of the DC-AC power converter 12. The voltage rating may be determined by considering the amount of voltage that the semiconductor switches can manage, for example. In a specific embodiment, the maximum threshold voltage is defined as a maximum DC bus voltage (V_{dc-bus}_{_{—max}}) that may be transferred from the plurality of photovoltaic modules 14 to the DC-AC power converter 12 in the solar power generation system 10. Based on the minimum threshold voltage (V_{dc-bus}_{_{—}}ₘᵢₙ) and the maximum threshold voltage (V_{dc-bus}_{_{—}}ₘₐₓ, the number and type of photovoltaic modules 14 are determined that would be capable of generating DC power while factoring in the minimum threshold voltage (V_{dc-bus}_{_{—}}ₘᵢₙ) and the maximum threshold voltage (V_{dc-bus}_{_{—}}ₘₐₓ). The plurality of photovoltaic modules 14 may be electrically coupled to each other in series, in parallel, or with a combination of series and parallel connections. In a specific embodiment, a plurality of photovoltaic sources is electrically coupled in series to form at least one string 18 of photovoltaic modules. In a more specific embodiment, the at least one string 18 is electrically coupled in parallel to at least one other string generate the DC power. A minimum number of photovoltaic modules in a string is defined by the voltage characteristic of the photovoltaic cells, the prevailing grid voltage and the desired operating envelope that define a photovoltaic system having a voltage at least as large as the minimum threshold voltage but no greater than the maximum threshold voltage.

If desired, a controller (not shown) of solar power generation system 10 may be used to operate switches of the DC-AC power converter 12 based on maximum power point tracking and grid voltage requirements to further control the output power from the DC-AC power converter 12.

For better understanding of the invention, a non-limiting example for determining a range of output voltage to be supplied by the plurality of photovoltaic modules is described below. Assuming that the grid voltage requirement (Vₗₗ_{_{—}}ᵣₘₛ) for a power grid is 460 volts, the primary minimum threshold voltage (V_{dc-bus}_{_{—}}ₘᵢₙ₁) to be supplied by the plurality of photovoltaic modules to the three level three phase DC-AC power converter for generating 460 volts is computed by the equation Vdc_bus_min1=π/4×√2×Vll_rms, that is 510V and Vdc-bus_min2=\sqrt{2}* Vll_rms that is √2*460 that equals to 650 volts. Therefore, 510 volts would be required to start operating the DC-AC converter, and 650 volts would be required for generating AC power in three-level mode feeding into an AC grid at 460 volts. If the three level three phase DC-AC power converter comprises 1200 volt insulated gate bipolar transistors (IGBTs), the nominal voltage rating for the DC-AC power converter would be between 900 volts and 1000 volts. The exact maximum voltage threshold depends on the electro-mechanical design of the power DC-AC converter reflected in the effective leakage inductance, the operating temperature, and the reverse recovery behavior of the inverse diodes chosen. Therefore, based on the individual DC power generating capacity of the photovoltaic modules, the number and type of photovoltaic modules would be determined such that the plurality of photovoltaic modules are able to generate the maximum annual energy product with a prevalent voltage in the range from 650 volts to 1000 volts based on the maximum power point controlled by the DC-AC power converter. For DC voltages outside the range 510V and 1000V, the DC-AC converter would be disconnected from the grid. The DC voltage is defined by the number and the type of modules in the series connection of the photovoltaic modules as well as by the amount of sunlight reaching the modules.

The plurality of photovoltaic modules transmit the DC power with at least minimum threshold voltage to the DC-AC power converter that converts the DC power to the AC power and supplies the AC power to the power grid. In one embodiment, the DC-AC power converter 12 is disconnected or switched off when conditions such as cloudy or nighttime conditions result in a situation wherein the plurality of photovoltaic modules cannot provide a voltage at least as great as the minimum threshold voltage.

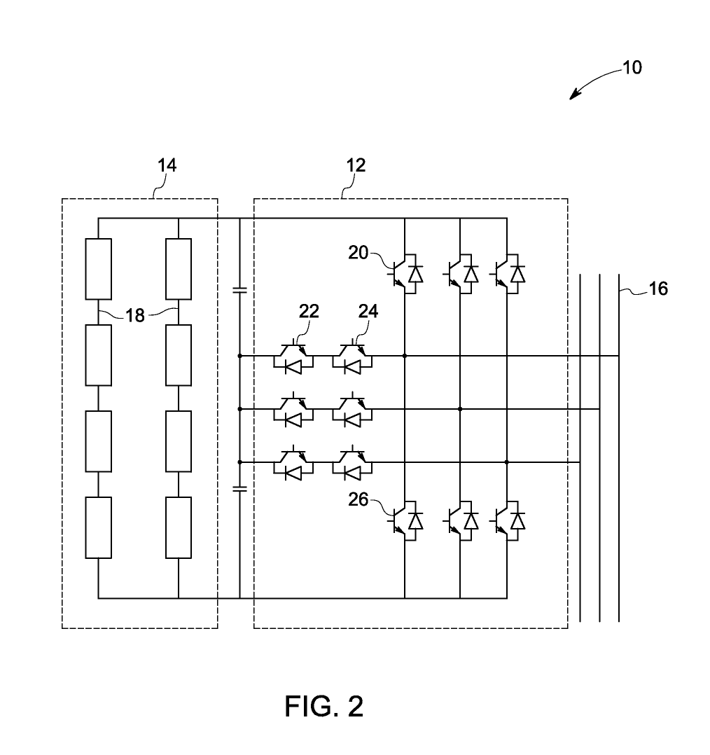

FIG. 2 is a schematic representation of an alternative embodiment of the solar power generation system comprising an alternative three-level three-phase DC-AC power converter in accordance with the invention. The operation of the alternative embodiment of the solar power generation system is similar to the operation of the above mentioned embodiment as described in FIG. 1.

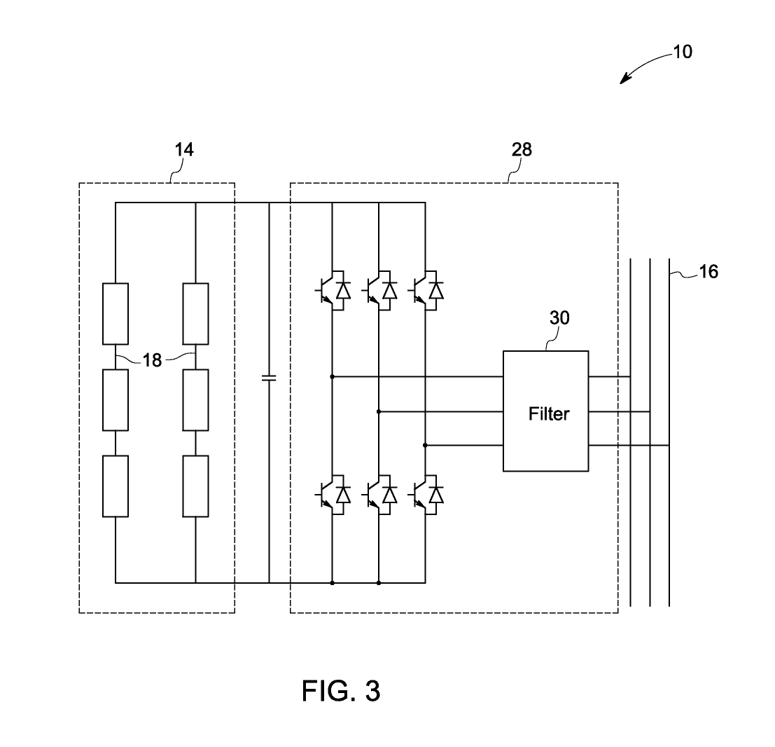

FIG. 3 depicts an alternative embodiment of the solar power generation system 10 including a two level three phase DC-AC power converter 28 in accordance with an embodiment of the invention. The alternative embodiment includes a two level three phase DC-AC power converter 28 for converting the DC power to AC power. The primary minimum threshold voltage (V_{dc-bus}_{_{—}}ₘᵢₙ₁) for a two level three phase power converter 28 installed in the solar power generation system 10, in one embodiment, comprises a voltage equal to

Vdc_bus_min1=π/4×√2×Vll_rms

The maximum threshold voltage (V_{dc-bus}_{_{—}}ₘₐₓ) and the plurality of photovoltaic modules for the embodiment of FIG. 3 may be determined in a similar manner as described above with respect to FIG. 1. If desired, an additional filter 30 may be coupled to the two level three phase power converter 28 to generate a sinusoidal AC power that can be supplied to the power grid 16. Although, only three exemplary configurations of DC-AC power converters in the solar power generation system 10 are described in the specification, the solar power generation system 10 can be adapted to operate with other types of DC-AC power converters as well.

In addition to the systems disclosed herein, the present invention also includes an embodiment comprising a method for fabricating a solar power generation system. The method includes coupling a plurality of photovoltaic modules to each other for generating DC power having a voltage at least as large as a minimum threshold voltage, based at least in part on a voltage requirement of a grid, but no greater than a maximum threshold voltage. In one embodiment, prior to coupling the plurality of photovoltaic modules to each other, the minimum threshold voltage and the maximum threshold voltage are determined. In a specific embodiment, determining the minimum threshold voltage includes determining the two threshold voltages V_{dc-bus}_{_{—}}ₘᵢₙ₁ and V_{dc-bus}_{_{—}}ₘᵢₙ₂ and adjusting the control system depending on whether the DC power is greater than either or both of the two threshold voltages. In a another specific embodiment, a secondary minimum threshold voltage, V_{dc-bus}_{_{—}}ₘᵢₙ₂ comprises a voltage equal to a square root of two times the grid voltage requirement of the solar power generation system, and a primary minimum threshold voltage V_{dc-bus}_{_{—}}ₘᵢₙ₁ equal to a product of one fourth portion of pi and the square root of two times the grid voltage requirement of the solar power generation system. In yet another specific embodiment, determining the minimum threshold voltage based on the grid voltage requirement includes determining the minimum threshold voltage based on a line to line root mean square voltage of the solar power generation system. The method also includes determining a maximum threshold voltage based on a power rating of a DC-AC power converter being employed in a solar power generation system. In another embodiment, electrically coupling the plurality of photovoltaic modules comprises electrically coupling the plurality of photovoltaic modules in series to form at least one string of photovoltaic modules capable of providing the minimum threshold voltage to the DC-AC power converter. In a more specific embodiment, at least one string of photovoltaic modules is electrically coupled in parallel to provide the minimum threshold voltage to the DC-AC power converter. In one embodiment, the DC-AC power converter is switched off when the plurality of photovoltaic sources provide a voltage less than the minimum threshold voltage to the DC-AC power converter.

The various embodiments of the solar power generation system described above provide a more efficient and reliable solar power generation system. The system described above enables a lower part count resulting in lower hardware and power generation expenses.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A solar power generation system comprising:
a plurality of photovoltaic modules electrically coupled to each other for generating DC power having a voltage at least as large as a minimum threshold voltage but no greater than a maximum threshold voltage; and
a DC-AC power converter comprising a plurality of semiconductor switches for converting the DC power to AC power and transmitting the AC power to a power grid,
wherein the minimum threshold voltage is based at least in part on grid voltage requirements and the maximum threshold voltage is based at least in part on a voltage rating of the power converter.

2. The system of claim 1, wherein the minimum threshold voltage comprises a voltage equal to a square root of two times the grid voltage requirements of the solar power generation system.

3. The system of claim 1, wherein the minimum threshold voltage comprises a voltage equal to a product of one fourth portion of pi and the square root of two times the grid voltage requirements of the solar power generation system.

4. The system of claim 1, wherein the grid voltage requirements comprise a line to line root mean square voltage of the solar power generation system.

5. The system of claim 1, wherein the plurality of photovoltaic modules are electrically coupled in series to form a string of photovoltaic modules.

6. The system of claim 5, wherein one or more strings of photovoltaic modules are electrically coupled in parallel to generate the predetermined minimum threshold voltage.

7. The system of claim 1, wherein the minimum threshold voltage and the maximum threshold voltage comprises a minimum DC bus voltage and a maximum DC bus voltage respectively.

8. The system of claim 1, further comprising a converter controller for switching off the DC-AC power converter when the plurality of photovoltaic modules provide a voltage less than the minimum threshold voltage to the DC-AC power converter.

9. A method comprising:
coupling a plurality of photovoltaic modules to each other for generating DC power having a voltage at least as large as a minimum threshold voltage but no greater than a maximum threshold voltage; and
coupling the plurality of photovoltaic modules to a DC-AC power converter,
wherein the minimum threshold voltage is based at least in part on grid voltage requirements and the maximum threshold voltage is based at least on part on a voltage rating of the DC-AC power converter.

10. The method of claim 9 further comprising, prior to coupling the plurality of photovoltaic modules to each other, determining the minimum threshold voltage and the maximum threshold voltage.

11. The method of claim 10, wherein determining the minimum threshold voltage comprises determining a voltage equal to a square root of two times the grid voltage requirement of the solar power generation system.

12. The method of claim 10, wherein determining the minimum threshold voltage comprises determining a voltage equal to a product of one fourth portion of pi and the square root of two times the grid voltage requirement of the solar power generation system.

13. The method of claim 10, wherein determining the minimum threshold voltage based on the grid voltage requirement comprises determining the minimum threshold voltage based on a line to line root mean square voltage of the solar power generation system.

14. The method of claim 9, wherein electrically coupling the plurality of photovoltaic modules comprises electrically coupling the plurality of photovoltaic modules in series to form at least one string of photovoltaic modules capable of providing the minimum threshold voltage to the DC-AC power converter.

15. The method of claim 14, further comprising electrically coupling at least one string of photovoltaic modules in parallel to provide the minimum threshold voltage to the DC-AC power converter.

16. A method comprising:
using a plurality of photovoltaic modules electrically coupled to each other for generating DC power having a voltage at least as large as a minimum threshold voltage; and
transmitting the DC power to a DC-AC power converter comprising a plurality of semiconductor switches for converting the DC power to AC power;
turning off the DC-AC power converter when the DC power transmitted to the DC-AC converter comprises a voltage less than the minimum threshold voltage.

17. The method of claim 16, wherein the DC-AC power converter comprises a three level, three phase power converter, and wherein the minimum threshold voltage comprises two minimum threshold voltages, and further comprising
operating the DC-AC power converter in a two level mode when the DC power falls between the two minimum threshold voltages, and
operating the DC-AC power converter in a three level mode when the DC power is greater than both minimum threshold voltages.
